(19) United States
(12) Patent Application Publication
(10) Pub. No.: US 2026/0148428 A1
(43) Pub. Date: May 28, 2026

(54) ADAPTIVE CLASSIFIER FREE GUIDANCE FOR DIFFUSION MODEL IMAGE GENERATION

(71) Applicant: ADOBE INC., SAN JOSE, CA (US)

(72) Inventors: Kuangxiao Gu, North Bend, WA (US); Lynn Hook, Mill Creek, WA (US); Jiancong Wang, South Jordan, UT (US); Aliakbar Darabi, Newcastle, WA (US)

(21) Appl. No.: 18/958,104

(22) Filed: Nov. 25, 2024

(51) Int. Cl. G06T 11/00

(52) U.S. Cl. CPC G06T 11/00

(57) ABSTRACT

Systems and methods for image processing include obtaining a guidance condition representing an image element and computing a conditioned tensor based the guidance condition and an unconditioned tensor independent of the guidance condition. An adaptive guidance strength is computed based on the guidance condition and the conditioned tensor and the unconditioned tensor are combined based on the adaptive guidance strength to obtain a scoring tensor. An image generation model generates a synthetic image depicting the image element based on the scoring tensor.

### BACKGROUND

The following relates generally to image processing, and more specifically to image generation. Image processing refers to the use of a computer to create or edit an image using an algorithm or a processing network. Image processing software can be used for various image processing tasks, such as image restoration, image detection, image editing, image compositing, and image generation.

Machine learning models, including deep neural networks, may be used to generate images or parts of images. However, when a machine learning model generates part of an image, the generated image may include artefacts, blurriness, and inconsistencies such as cloudiness in fore-ground-background transition regions. This results in an unnatural looking image.

### SUMMARY

The present disclosure describes systems and methods for image processing including an image generation model based on a deep neural network such as a guided diffusion model. Embodiments include an image generation model that generates images with natural-looking transitions between foreground and background. Embodiments utilize an adaptive classifier free guidance (CFG) process that mitigates artifacts that arise during image generation.

A method, apparatus, non-transitory computer readable medium, and system for image processing are described. One or more aspects of the method, apparatus, non-transitory computer readable medium, and system include obtaining a guidance condition representing an image element; computing a conditioned tensor based the guidance condition and an unconditioned tensor independent of the guidance condition; computing an adaptive guidance strength based on the guidance condition; combining the conditioned tensor and the unconditioned tensor based on the adaptive guidance strength to obtain a scoring tensor; and generating, using an image generation model, a synthetic image depicting the image element based on the scoring tensor.

A method, apparatus, non-transitory computer readable medium, and system for image processing are described. One or more aspects of the method, apparatus, non-transitory computer readable medium, and system include obtaining a guidance condition; computing a conditioned tensor using the guidance condition; computing an unconditioned tensor; combining the conditioned tensor and the unconditioned tensor based on a comparison between the conditioned tensor and the unconditioned tensor to obtain a scoring tensor; and generating, using an image generation model, a synthetic image depicting the image element based on the scoring tensor.

### BRIEF DESCRIPTION OF THE DRAWINGS

FIG. 1 shows an example of a guided diffusion model according to aspects of the present disclosure.

FIG. 2 shows an example of a U-Net according to aspects of the present disclosure.

FIG. 3 shows an example of a method for conditional media generation according to aspects of the present disclosure.

FIG. 4 shows a diffusion process according to aspects of the present disclosure.

FIG. 5 shows a flow diagram depicting an algorithm as a step-by-step procedure for training a machine-learning model according to aspects of the present disclosure.

FIG. 6 shows an example of a method for training a diffusion model according to aspects of the present disclosure.

FIG. 7 shows an example of a computing device according to aspects of the present disclosure.

FIG. 8 shows an example of an image processing apparatus according to aspects of the present disclosure.

FIG. 9 shows an example of a method for image processing according to aspects of the present disclosure.

FIG. 10 shows an example of an image artifact and an artifact-free image according to aspects of the present disclosure.

FIG. 11 shows an example of a series of intermediate images according to aspects of the present disclosure.

FIG. 12 shows an example of adaptive guidance strength according to aspects of the present disclosure.

### DETAILED DESCRIPTION

The present disclosure describes systems and methods for image processing including an image generation model based on a deep neural network such as a guided diffusion model. Image generation models generate a wide variety of images based on random or semi-random input. In some cases a complete image is generated and in other cases a portion of an image is generated. However, in some cases, generated content includes unwanted artifacts such as cloudiness, unnatural looking coloration, or inconsistencies.

Some embodiments of the disclosure use Classifier-free guidance (CFG) techniques. CGF is a method used in generative models, particularly diffusion models, to control how strongly a model adheres to a desired condition (e.g., a specific prompt or label). CFG models adjust the generation process to balance unconditional generation (i.e., where the model generates content without any specific guidance or condition) and conditional generation (where the model generates content based on a specific input or condition, such as a text prompt, class label, or other form of instruction). In classifier-free guidance, both the conditional and unconditional outputs of the model are combined. The technique allows control over how much emphasis to place on the condition. By tuning the balance, the model can be encouraged to create outputs that better align with the desired input, while still avoiding overly strict adherence that might harm the quality or diversity of the output.

Conventional models apply conditioning uniformly throughout and image, which can result in unwanted artifacts such as background textures that appear unnatural due to influence of the conditioning when it isn't appropriate. Embodiments of the disclosure enable cleaner-looking images, particularly in areas surrounding (but not included) in a foreground object. Some embodiments of the disclosure improve on conventional image generation models by generating more accurate output using adaptive CFG.

For example, guidance strength can be adjusted differently for different parts of an image based on attention layers within the model. In some embodiments a cosine similarity between positive and negative guidance is extracted from an attention layer and used to adapt the guidance strength applied. In some cases, this results in more guidance between applied to foreground objects, which can enable more consistency in the generation of background regions (that is, increased consistency can be achieved by applying less guidance in these regions).

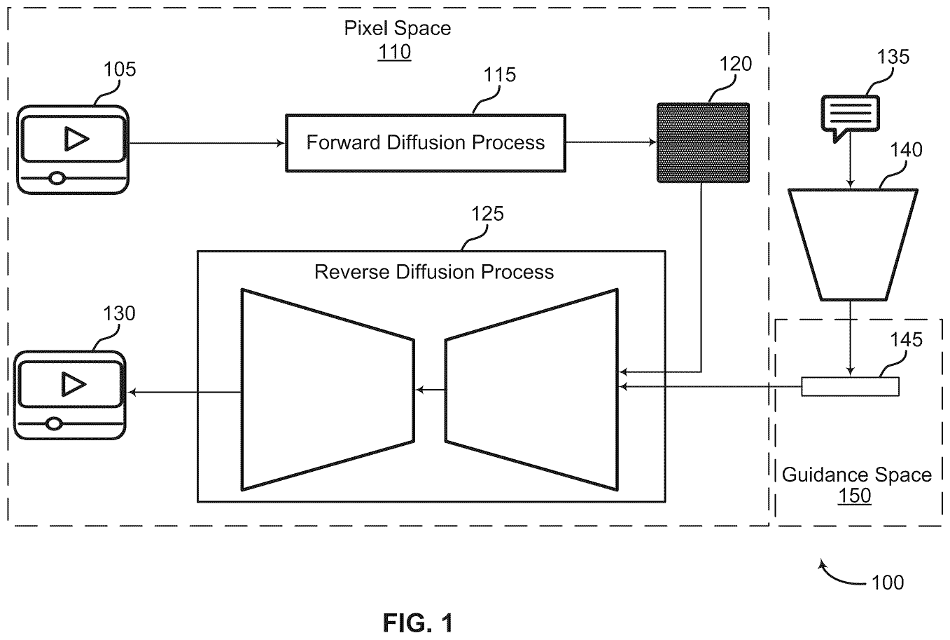

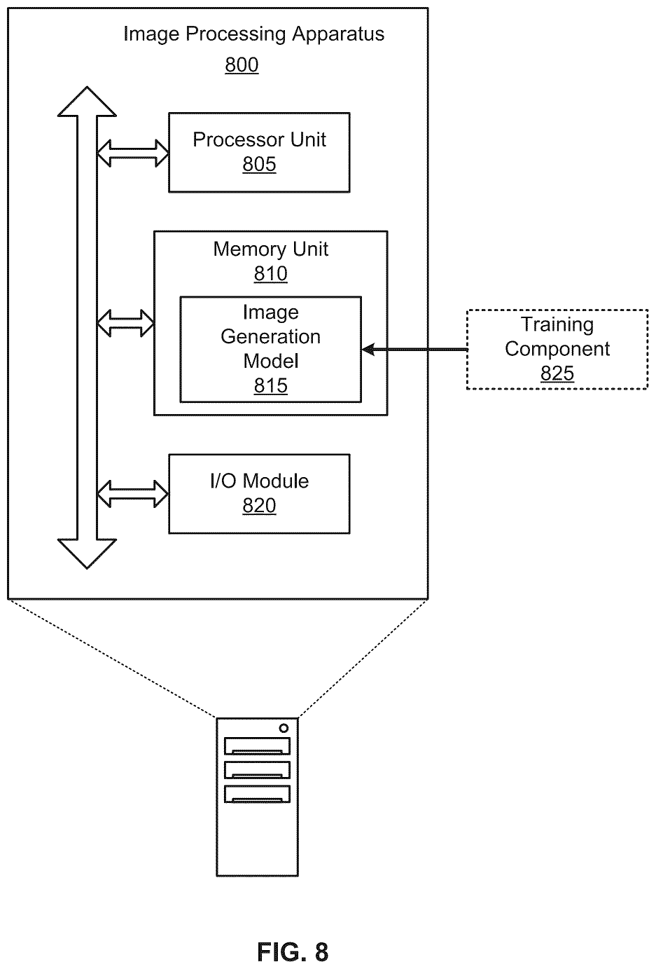

FIG. 1 shows an example of a guided diffusion model 100 according to aspects of the present disclosure. In some examples, guided diffusion model 100 describes the operation and architecture of the image generation model 815 described with reference to FIG. 8. The guided latent diffusion model 100 depicted in FIG. 1 is an example of, or includes aspects of, a media generation model as described herein. In some cases, guided diffusion model 100 uses adaptive CFG to generates more accurate images, such as images with more consistent background regions.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 100 may take an original media item 105 in a pixel space 110 as input and apply forward diffusion process 130 to gradually add noise to the original media item 105 to obtain noisy media item 120 at various noise levels.

Next, a reverse diffusion process 125 (e.g., a U-Net) gradually removes the noise from the noisy media item 120 at the various noise levels to obtain an output media item 130. In some cases, an output media item 130 is created from each of the various noise levels. The output media item 130 can be compared to the original media item 105 to train the reverse diffusion process 125.

The reverse diffusion process 125 can also be guided based on a text prompt 135, or another guidance prompt, such as an image, a layout, a segmentation map, etc. The text prompt 135 can be encoded using a text encoder 165 (e.g., a multimodal encoder) to obtain guidance features 145 in guidance space 150. The guidance features 145 can be combined with the noisy media item 120 at one or more layers of the reverse diffusion process 125 to ensure that the output media item 130 includes content described by the text prompt 135. For example, guidance features 145 can be combined with the noisy features using a cross-attention block within the reverse diffusion process 125.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

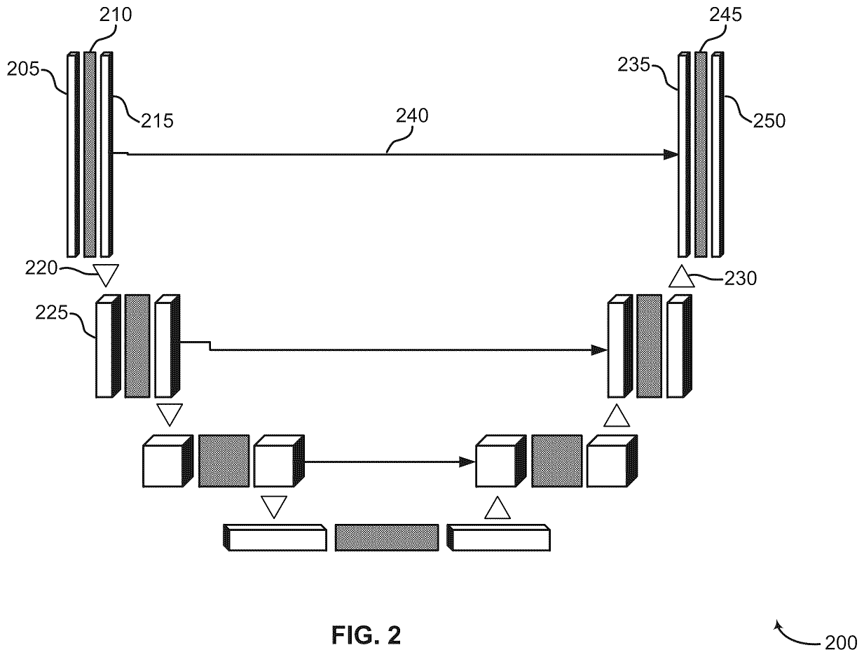

FIG. 2 shows an example of a U-Net 200 according to aspects of the present disclosure. In some examples, U-Net 200 is an example of the component that performs the reverse diffusion process 125 of guided diffusion model 100 described with reference to FIG. 1 and includes architectural elements of the image generation model 815 described with reference to FIG. 8. The U-Net 200 depicted in FIG. 2 is an example of, or includes aspects of, the architecture used within the reverse diffusion process described with reference to FIG. 1.

In some examples, diffusion models are based on a neural network architecture known as a U-Net. The U-Net 200 takes input features 205 having an initial resolution and an initial number of channels and processes the input features 205 using an initial neural network layer 210 (e.g., a convolutional network layer) to produce intermediate features 215. The intermediate features 215 are then down-sampled using a down-sampling layer 220 such that down-sampled features 225 features have a resolution less than the initial resolution and a number of channels greater than the initial number of channels.

This process is repeated multiple times, and then the process is reversed. That is, the down-sampled features 225 are up-sampled using up-sampling process 230 to obtain up-sampled features 235. The up-sampled features 235 can be combined with intermediate features 215 having the same resolution and number of channels via a skip connection 240. These inputs are processed using a final neural network layer 245 to produce output features 250. In some cases, the output features 250 have the same resolution as the initial resolution and the same number of channels as the initial number of channels.

In some cases, U-Net 200 takes additional input features to produce conditionally generated output. For example, the additional input features could include a vector representation of an input prompt. The additional input features can be combined with the intermediate features 215 within the neural network at one or more layers. For example, a cross-attention module can be used to combine the additional input features and the intermediate features 215.

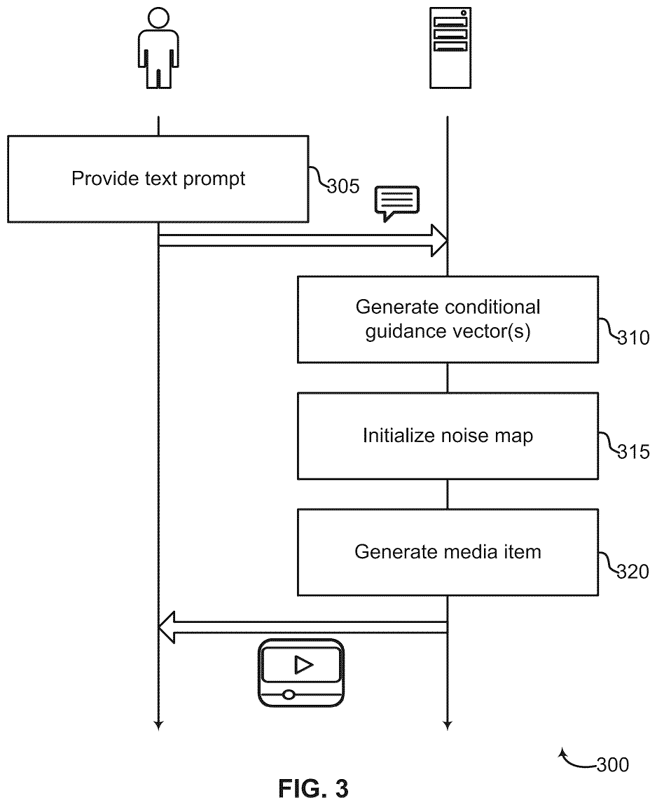

FIG. 3 shows an example of a method 300 for conditional media generation according to aspects of the present disclosure. In some examples, method 300 describes an operation of the image generation model 815 described with reference to FIG. 8 such as an application of the guided diffusion model 100 described with reference to FIG. 1. In some examples, these operations are performed by a system including a processor executing a set of codes to control functional elements of an apparatus such as the media generation model described in FIG. 1.

Additionally or alternatively, steps of the method 300 may be performed using special-purpose hardware. Generally, these operations are performed according to the methods and processes described in accordance with aspects of the present disclosure. In some cases, the operations described herein are composed of various substeps or are performed in conjunction with other operations.

At operation 305, a user provides a text prompt describing content to be included in a generated media item. For example, a user may provide the prompt “a person playing with a cat”. In some examples, guidance can be provided in a form other than text, such as via an image, a sketch, or a layout.

At operation 310, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 315, a noise map is initialized that includes random noise. The noise map may be in a pixel space or a latent space. By initializing a media item with random noise, different variations of a media item including the content described by the conditional guidance can be generated.

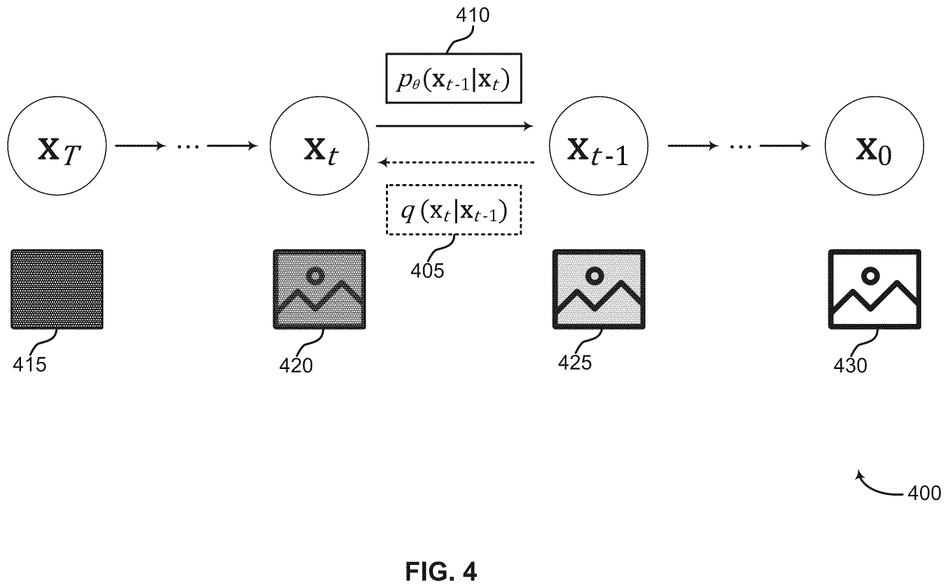

At operation 320, the system generates a media item based on the noise map and the conditional guidance vector. For example, the media item may be generated using a reverse diffusion process as described with reference to FIG. 4.

FIG. 4 shows a diffusion process 400 according to aspects of the present disclosure. In some examples, diffusion process 400 describes an operation of the image generation model 815 described with reference to FIG. 8, such as the reverse diffusion process 125 of guided diffusion model 100 described with reference to FIG. 1.

As described above with reference to FIG. 1, using a diffusion model can involve both a forward diffusion process 405 for adding noise to a media item (or features in a latent space) and a reverse diffusion process 410 for denoising the media item (or features) to obtain a denoised media item. The forward diffusion process 405 can be represented as q(xₜ|xₜ₋₁), and the reverse diffusion process 410 can be represented as p(xₜ₋₁|xₜ). In some cases, the forward diffusion process 405 is used during training to generate media items with successively greater noise, and a neural network is trained to perform the reverse diffusion process 410 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 410, the model begins with noisy data x_{T}, such as a noisy media item 415 and denoises the data to obtain the p(xₜ₋₁|xₜ). At each step t−1, the Reverse Diffusion process 410 takes xₜ, such as first intermediate media item 420, and t as input. Here, t represents a step in the sequence of transitions associated with different noise levels, The reverse diffusion process 410 outputs xₜ₋₁, such as second intermediate media item 425 iteratively until x_{T} reverts back to x₀, the original media item 430. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x+)=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and x represents the generated item with high quality.

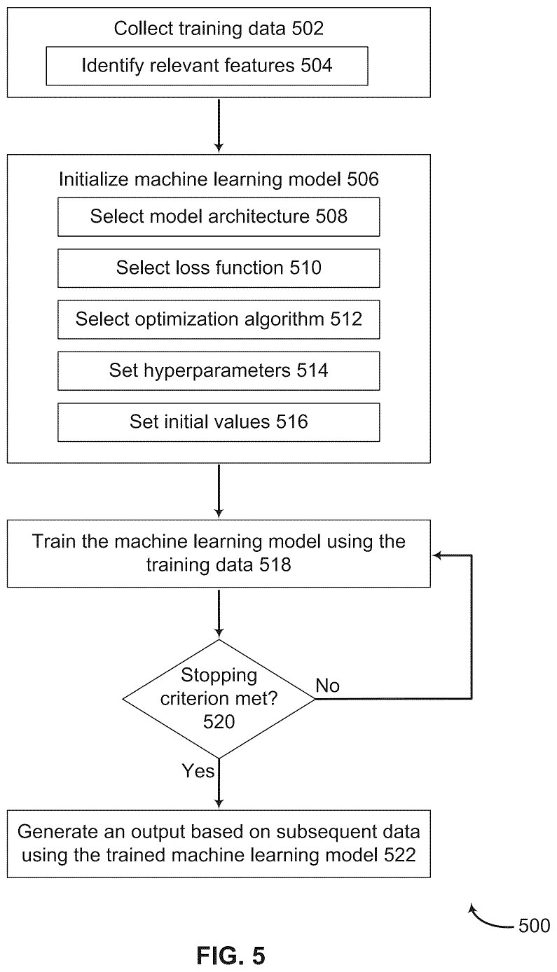

FIG. 5 is a flow diagram depicting an algorithm as a step-by-step procedure 500 in an example implementation of operations performable for training a machine-learning model. In some embodiments, the procedure 500 describes an operation of the training component 825 described for configuring the image generation model 815 as described with reference to FIG. 8. The procedure 500 provides one or more examples of generating training data, use of the training data to train a machine-learning model, and use of the trained machine-learning model to perform a task.

To begin in this example, a machine-learning system collects training data (block 502) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 504) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 506). Initialization of the machine-learning model includes selecting a model architecture (block 508) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 510). The loss function is utilized to measure a difference between an output of the machine-learning model (i.e., predictions) and target values (e.g., as expressed by the training data) to be used to train the machine-learning model. Additionally, an optimization algorithm is selected (512) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 514) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 518) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 520), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 520), the procedure 500 continues training of the machine-learning model using the training data (block 518) in this example.

If the stopping criterion is met (“yes” from decision block 520), the trained machine-learning model is then utilized to generate an output based on subsequent data (block 522). The trained machine-learning model, for instance, is trained to perform a task as described above and therefore, once trained, is configured to perform that task based on subsequent data received as an input and processed by the machine-learning model.

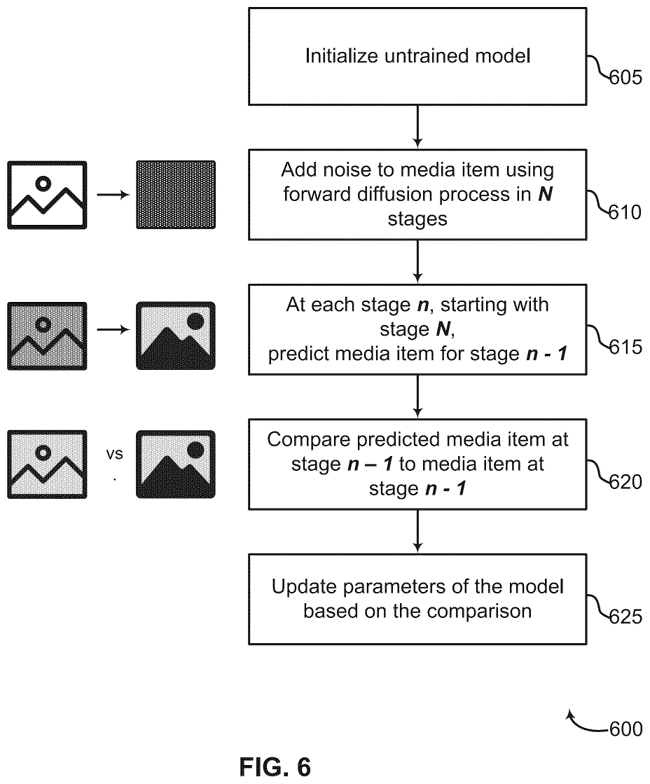

FIG. 6 shows an example of a method 600 for training a diffusion model according to aspects of the present disclosure. In some embodiments, the method 600 describes an operation of the training component 825 described for configuring the image generation model 815 as described with reference to FIG. 8. The method 600 represents an example for training a reverse diffusion process as described above with reference to FIG. 4. In some examples, these operations are performed by a system including a processor executing a set of codes to control functional elements of an apparatus, such as the guided diffusion model described in FIG. 1.

Additionally or alternatively, certain processes of method 600 may be performed using special-purpose hardware. Generally, these operations are performed according to the methods and processes described in accordance with aspects of the present disclosure. In some cases, the operations described herein are composed of various substeps or are performed in conjunction with other operations.

At operation 605, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 610, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 615, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 620, the system compares predicted output (or features) at stage n−1 to an actual media item (or features), such as the output at stage n−1 or the original input. For example, given observed data x, the diffusion model may be trained to minimize the variational upper bound of the negative log-likelihood-log pe (x) of the training data.

At operation 625, the system updates parameters of the model based on the comparison. For example, parameters of a U-Net may be updated using gradient descent. Time-dependent parameters of the Gaussian transitions can also be learned.

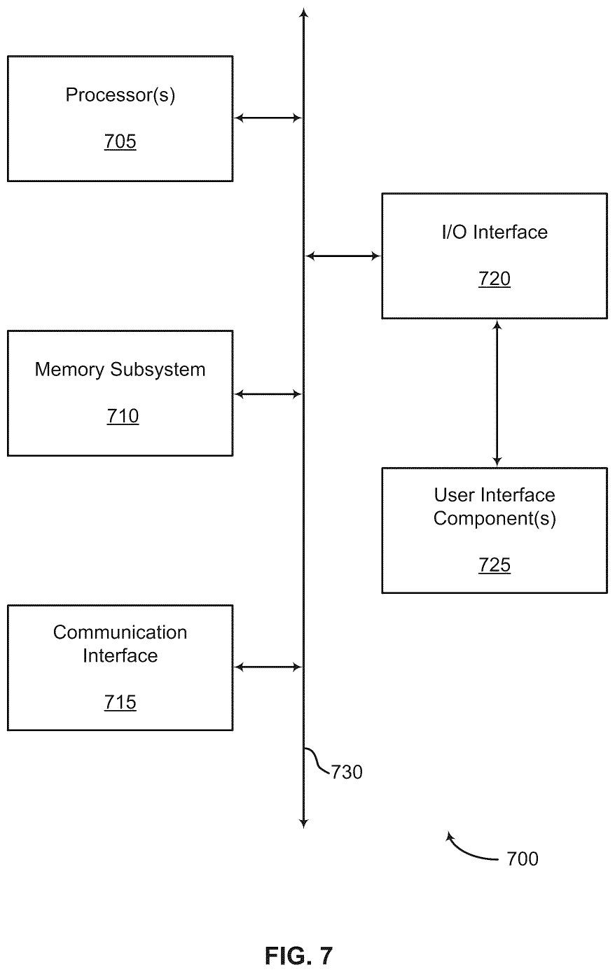

FIG. 7 shows an example of a computing device 700 according to aspects of the present disclosure. The computing device 700 may be an example of the image processing apparatus 800 described with reference to FIG. 8. In one aspect, computing device 700 includes processor(s) 705, memory subsystem 710, communication interface 715, I/O interface 720, user interface component(s) 725, and channel 730.

In some embodiments, computing device 700 is an example of, or includes aspects of, the media generation model of FIG. 1. In some embodiments, computing device 700 includes one or more processors 705 that can execute instructions stored in memory subsystem 710 to perform media generation.

According to some aspects, computing device 700 includes one or more processors 705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 715 operates at a boundary between communicating entities (such as computing device 700, one or more user devices, a cloud, and one or more databases) and channel 730 and can record and process communications. In some cases, communication interface 715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 720 is controlled by an I/O controller to manage input and output signals for computing device 700. In some cases, I/O interface 720 manages peripherals not integrated into computing device 700. In some cases, I/O interface 720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 720 or via hardware components controlled by the I/O controller.

According to some aspects, user interface component(s) 725 enable a user to interact with computing device 700. In some cases, user interface component(s) 725 include an audio device, such as an external speaker system, an external display device such as a display screen, an input device (e.g., a remote-control device interfaced with a user interface directly or through the I/O controller), or a combination thereof. In some cases, user interface component(s) 725 include a GUI.

FIG. 8 shows an example of an image processing apparatus 800 according to aspects of the present disclosure. Image processing apparatus 800 may include an example of, or aspects of, the guided diffusion model described with reference to FIG. 1 and the U-Net described with reference to FIG. 2. In some embodiments, image processing apparatus 800 includes processor unit 805, memory unit 810, image generation model 815, I/O module 820, and training component 825. Training component 825 updates parameters of the image generation model 815 stored in memory unit 810. In some examples, the training component 825 is located outside the image processing apparatus 800.

Processor unit 805 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 805 is configured to operate a memory array using a memory controller. In other cases, a memory controller is integrated into processor unit 805. In some cases, processor unit 805 is configured to execute computer-readable instructions stored in memory unit 810 to perform various functions. In some aspects, processor unit 805 includes special purpose components for modem processing, baseband processing, digital signal processing, or transmission processing. According to some aspects, processor unit 805 comprises one or more processors described with reference to FIG. 7.

Memory unit 810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 805 to perform various functions described herein.

In some cases, memory unit 810 includes a basic input/output system (BIOS) that controls basic hardware or software operations, such as an interaction with peripheral components or devices. In some cases, memory unit 810 includes a memory controller that operates memory cells of memory unit 810. For example, the memory controller may include a row decoder, column decoder, or both. In some cases, memory cells within memory unit 810 store information in the form of a logical state. According to some aspects, memory unit 810 is an example of the memory subsystem 710 described with reference to FIG. 7.

According to some aspects, image processing apparatus 800 uses one or more processors of processor unit 805 to execute instructions stored in memory unit 810 to perform functions described herein. For example, the image processing apparatus 800 may perform image generation using adaptive CFG.

The memory unit 810 may include an image generation model 815 trained to perform image generation using adaptive CFG. For example, after training, the image generation model 815 may perform inferencing operations as described with reference to FIGS. 3 and 4 to perform image generation using adaptive CFG.

In some embodiments, the image generation model 815 is an artificial neural network (ANN) such as the guided diffusion model described with reference to FIG. 1 and the U-Net described with reference to FIG. 2. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 815 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 825 may train the image generation model 815. For example, parameters of the image generation model 815 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 5 and 6). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 815 can be used to make predictions on new, unseen data (i.e., during inference).

I/O module 820 receives inputs from and transmits outputs of the image processing apparatus 800 to other devices or users. For example, I/O module 820 receives inputs for the image generation model 815 and transmits outputs of the image generation model 815. According to some aspects, I/O module 820 is an example of the I/O interface 720 described with reference to FIG. 7.

In some cases, an image generation mode includes convolutional neural network (CNN) layers. A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

According to some aspects, obtains the guidance condition includes obtaining a text prompt describing the image element; and encoding the text prompt to obtain the guidance condition.

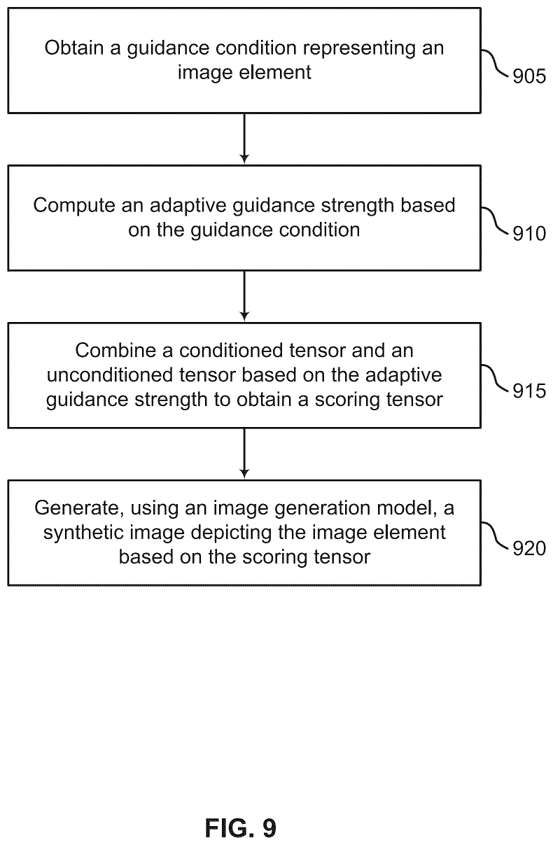

FIG. 9 shows an example of a method 900 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 905, the system obtains a guidance condition representing an image element. In some cases, the operations of this step refer to, or may be performed by, an image generation model as described with reference to FIGS. 1-2. For example a user could provide a text prompt describing an image to be generated and the text prompt could be encoded to obtain the guidance condition. Alternatively, the guidance condition could be an image depicting a foreground object. Since both text prompts and reference images might describe or depict foreground objects more than background elements, it may be appropriate to apply guidance more strongly in generating foreground objects to be consistent with the target guidance. However, applying the guidance to background regions might result in unwanted artifacts.

At operation 910, the system computes an adaptive guidance strength based on the guidance condition. In some cases, the operations of this step refer to, or may be performed by, an image generation model as described with reference to FIGS. 1-2.

In some embodiments, the guidance strength is adaptively adjusted based on a metric. Different metrics can be used, including the Euclidean difference or cosine similarity between positive and negative tensors (i.e., score functions). Additionally or alternatively, an attention map extracted from a diffusion model's attention layers may be used. For example, areas that the attention map indicate are relevant to the guidance may use a higher guidance strength. In some cases, additional tuning parameters has been introduced in adaptive algorithm to further tune the adaptive schedule (e.g., based on a timestep or an amount of noise remaining). These additional parameters may be based on position, structural inputs from a user (i.e., the user could explicitly specify where to apply guidance), etc. In some cases, additional parameters could improve detail preservation.

At operation 915, the system combines a conditioned tensor and an unconditioned tensor based on the adaptive guidance strength to obtain a scoring tensor. In some cases, the operations of this step refer to, or may be performed by, an image generation model as described with reference to FIGS. 1-2.

Given a generative model that produces samples x conditioned on some input c (e.g., a text prompt) and unconditionally (no conditioning), the goal is to generate samples that balance between following the condition and maintaining general sample quality. The CFG process may apply the noise prediction in diffusion models as follows:

Unconditional noise prediction ∈_{uncond}(xₜ) may be the noise predicted by the model unconditionally (i.e., without the condition) and ∈_{cond}(xₜ) may be the noise predicted by the model based on the condition. The guided noise prediction may be computed as

$${ϵ}_{guided} ( {x}_{t} , c ) = {ϵ}_{uncond} ( {x}_{t} ) + ω ( y ) \cdot ( {ϵ}_{cond} ( {x}_{t} , c ) - {ϵ}_{uncond} ( {x}_{t} ) ) .$$

Here, ω(y) is the adaptive guidance. Unlike traditional CFG, ω is a function of the location, y, within the image (e.g., based on differences between a positive and negative scoring function, or based on an attention map). A higher ω places more weight on the conditional prediction, making the output more aligned with the input condition, c. Lower values of ω reduce the influence of the condition, leading to more creative, diverse, and consistent outputs. In some cases, no guidance is applied at any part of the image during some timesteps (i.e., timesteps near the end of the generation process).

At operation 920, the system generates, using an image generation model, a synthetic image depicting the image element based on the scoring tensor. In some cases, the operations of this step refer to, or may be performed by, an image generation model as described with reference to FIGS. 1-2. In some cases, the synthetic image is generated using an iterative process of noise removal over multiple diffusion timesteps are described above.

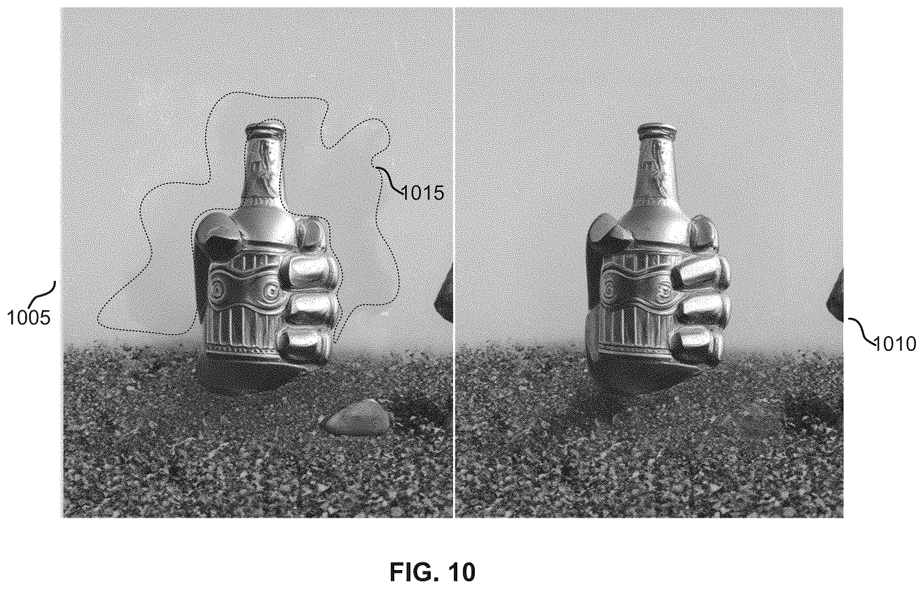

FIG. 10 shows an example of an image artifact and an artifact-free image according to aspects of the present disclosure. The example illustrated in FIG. 10 includes image 1005 that includes artifact 1015, and artifact-free image 1010 generated using systems and methods described herein. In this example, a prompt such as a text prompt “a statute of a hand holding a bottle” may be provided, and the image may be generated based on the prompt and, optionally, a reference image showing the desired background. Then image, or portions of the image may be generated based on these inputs.

A conventional image generation model may produce an output such as image 1005 that includes artifact 1015 because guidance is applied to background regions that do not depend on that guidance. Therefore, by applying adaptive CFG to apply the guidance where appropriate, artifact-free image 1010 may be generated.

In some embodiments, the artifact-free image 1010 is generated by obtaining a guidance condition representing an image element. For example the guidance condition could be based on an image or a text prompt stating “a statue of a hand holding a bottle”. An image generation model can compute a conditioned tensor based the guidance condition and an unconditioned tensor independent of the guidance condition (e.g. using a UNet that performs a denoising operation to generate a new image). The conditioned tensor can indicate noise to be removed to generate the synthetic image, and it is computed based on the guidance condition. Therefore, the conditioned tensor may be largely influenced by the guidance from the text prompt. The unconditioned tensor also indicate noise to be removed to generate the synthetic image. However, the unconditioned tensor is not influenced by the guidance and simply predicts noise to be removed based on the existing context in the image being generated.

Once the image generation model has removed some noise (i.e., at an intermediate denoising step), a general shape of the target object begins to appear. At this point, it is more important to generate certain areas representing the target object based on the guidance, but areas that don't represent the target object (i.e., the area immediately surrounding the hand holding the bottle) can be generated more accurately based on context rather than in reference to the guidance. Therefore, the adaptive guidance strength indicates where the guidance prompt is relevant and applies the conditioned tensor in those areas. Where the guidance prompt is not relevant (e.g., in background areas) the unconditioned tensor is used (or weighted more heavily) so that these areas are consistent with the surrounding textures (as opposed to textures indicated in the guidance). In some cases, generating the conditioned tensor and the unconditioned tensor involves running aspects of the image generation model twice (once with guidance and once without guidance). Then a combination of the outputs is used to remove the noise. This process can then be repeated at multiple diffusion timesteps.

An adaptive guidance strength is computed based on the guidance condition and the conditioned tensor. For example, the guidance strength can be computed based on an attention output that indicates where the guidance is relevant, or based on a similarity between the conditioned tensor and unconditioned tensor (since the areas impacted by the guidance will be more different than areas not based on the guidance).

The unconditioned tensor are then combined based on the adaptive guidance strength to obtain a scoring tensor. The combination can either be based on using features from one or the other, or by using a weighted combination of them at different spatial locations according to the adaptive guidance strength. An image generation model generates a synthetic image depicting the image element by denoising an image based on the scoring tensor.

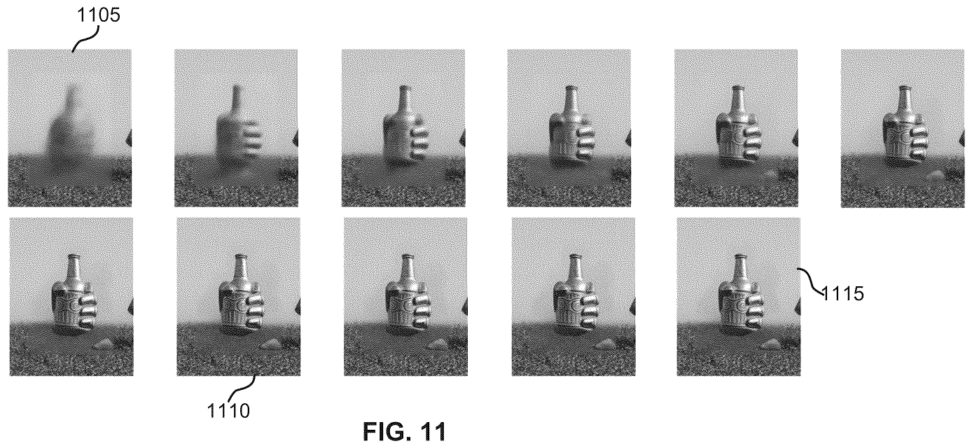

FIG. 11 shows an example of a series of intermediate images according to aspects of the present disclosure. The images may include a first image 1105, a second image 1110, and third image 1115 generated at different diffusion timesteps. For example, first image 1105 may be an input image or an image generated at a first timestep, second image 1110 may be generated at a 70th timestep, and third image 1115 may be generated at a 100^{th} or final timestep. However, these are examples, and any number of timesteps may be used. In some examples, an image is generated at each timestep and in other cases images are generated only at selected timesteps according to a denoising schedule. In some cases, the adaptive CFG can be based on local 12-channel cosine similarity between xₚₒₛ & x_{neg}. For example, a color patch can start to appear around step 15 and become more visible towards the end of diffusion process.

According to the example shown in FIG. 11, distortions may exist in the initial input images, but a basic structure of the final foreground object may be present at an intermediate timestep such as in second image 1110. At this point, applying guidance in the background region may prevent the model from removing the distortion, resulting in the presence or artifacts such as those illustrated in FIG. 10 in the third image 1115.

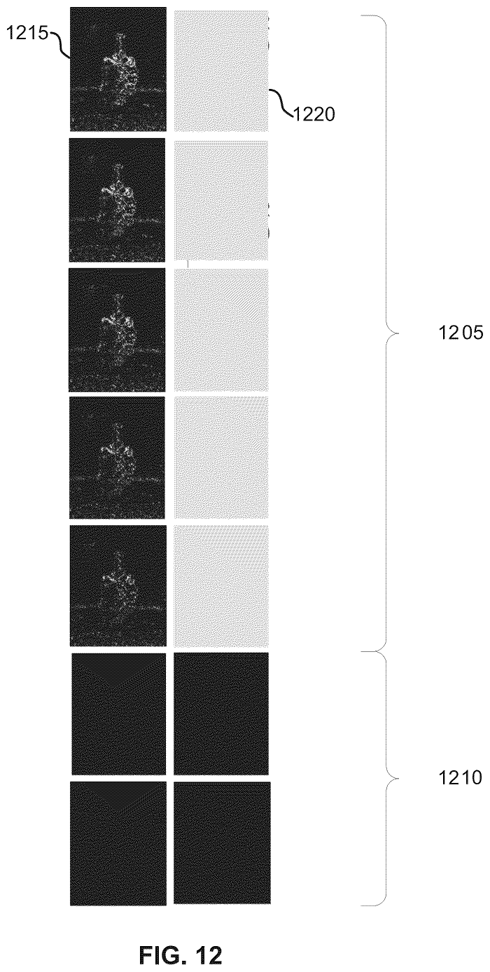

FIG. 12 shows an example of adaptive guidance strength according to aspects of the present disclosure. FIG. 12 shows two columns illustrating the application of classifier guidance in a first stage 1205 corresponding to a first set of timesteps for an image such as the image shown in FIGS. 10-11. During a second stage 1210, guidance may not be applied. The left column shows an example of adaptive CFG for each pixel (e.g., based on differences between a positive and negative tensors, conditional and unconditional guidance, or based on an attention map). The guidance strength may be much higher on the foreground object than its surrounding background. The lowered guidance on background region makes the color patch artifact disappear, whereas the higher guidance on foreground object preserves detail and consistency with the guidance inputs. In comparison, the right column shows a conventional guidance schedule where a fixed value for the classifier is applied across all spatial locations (and diffusion steps except for last two steps where guidance is disabled).

Accordingly, a method for image processing is described. One or more aspects of the method include obtaining a guidance condition representing an image element; computing an adaptive guidance strength based on the guidance condition; combining a conditioned tensor and an unconditioned tensor based on the adaptive guidance strength to obtain a scoring tensor; and generating, using an image generation model, a synthetic image depicting the image element based on the scoring tensor.

Some examples of the method, apparatus, non-transitory computer readable medium, and system further include obtaining a text prompt describing the image element and encoding the text prompt to obtain the guidance condition. Some examples of the method, apparatus, non-transitory computer readable medium, and system further include computing the conditioned tensor based on the guidance condition; computing the unconditioned tensor independent of the guidance condition; and computing a similarity between the conditioned tensor and the unconditioned tensor, wherein the adaptive guidance strength is based on the similarity.

Some examples of the method, apparatus, non-transitory computer readable medium, and system further include computing an attention map based on the guidance condition, wherein the adaptive guidance strength is based on the attention map. Some examples of the method, apparatus, non-transitory computer readable medium, and system further include determining an adaptive schedule, wherein adaptive guidance strength is further based on the adaptive schedule.

Some examples of the method, apparatus, non-transitory computer readable medium, and system further include obtaining a noise map; and denoising the noise map based on the scoring tensor. Some examples of the method, apparatus, non-transitory computer readable medium, and system further include iteratively updating the adaptive guidance strength at a diffusion timestep; and computing the scoring tensor for the diffusion timestep based on the updated adaptive guidance strength.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image processing, the method comprising:
obtaining a guidance condition representing an image element;
computing a conditioned tensor based the guidance condition and an unconditioned tensor independent of the guidance condition;
computing an adaptive guidance strength based on the guidance condition;
combining the conditioned tensor and the unconditioned tensor based on the adaptive guidance strength to obtain a scoring tensor; and
generating, using an image generation model, a synthetic image depicting the image element based on the scoring tensor.

2. The method of claim 1, wherein:
the adaptive guidance strength varies based on pixel location.

3. The method of claim 1, wherein computing the adaptive guidance strength comprises:
computing a similarity between the conditioned tensor and the unconditioned tensor, wherein the adaptive guidance strength is based on the similarity.

4. The method of claim 1, wherein computing the adaptive guidance strength comprises:
computing an attention map based on the guidance condition, wherein the adaptive guidance strength is based on the attention map.

5. The method of claim 1, wherein computing the adaptive guidance strength comprises:
determining an adaptive schedule, wherein adaptive guidance strength is further based on the adaptive schedule.

6. The method of claim 1, wherein generating the synthetic image comprises:
obtaining a noise map; and
denoising the noise map based on the scoring tensor.

7. The method of claim 1, wherein generating the synthetic image comprises:
iteratively updating the adaptive guidance strength at a diffusion timestep; and
computing the scoring tensor for the diffusion timestep based on the updated adaptive guidance strength.

8. A non-transitory computer readable medium storing code for image processing, the code comprising instructions that, when executed by at least one processor, cause the at least one processor to perform operations comprising:
obtaining a guidance condition;
computing a conditioned tensor using the guidance condition;
computing an unconditioned tensor;
combining the conditioned tensor and the unconditioned tensor based on a comparison between the conditioned tensor and the unconditioned tensor to obtain a scoring tensor; and
generating, using an image generation model, a synthetic image depicting the image element based on the scoring tensor.

9. The non-transitory computer readable medium of claim 8, the code further comprising instructions that, when executed by the at least one processor, cause the at least one processor to perform operations comprising:
obtaining a text prompt describing the image element; and
encoding the text prompt to obtain the guidance condition.

10. The non-transitory computer readable medium of claim 8, further comprising:
computing an adaptive guidance strength based on the conditioned tensor and the unconditioned tensor, wherein the conditioned tensor and the unconditioned tensor are combined based on the adaptive guidance strength.

11. The non-transitory computer readable medium of claim 8, wherein combining the conditioned tensor and the unconditioned tensor:
computing an attention map based on the guidance condition, wherein the conditioned tensor and the unconditioned tensor are combined based on the attention map.

12. The non-transitory computer readable medium of claim 8, wherein computing the adaptive guidance strength comprises:
determining an adaptive schedule, wherein adaptive guidance strength is further based on the adaptive schedule.

13. The non-transitory computer readable medium of claim 8, the code further comprising instructions that, when executed by the at least one processor, cause the at least one processor to perform operations comprising:
obtaining a noise map; and
denoising the noise map based on the scoring tensor.

14. The non-transitory computer readable medium of claim 8, the code further comprising instructions that, when executed by the at least one processor, cause the at least one processor to perform operations comprising:
iteratively updating an adaptive guidance strength at a diffusion timestep; and
computing the scoring tensor for the diffusion timestep based on the updated adaptive guidance strength.

15. A system comprising:
a memory component;
a processing device coupled to the memory component; and
an image generation model comprising parameters stored in the memory component and configured to compute an adaptive guidance strength for combining a conditioned tensor and an unconditioned tensor that is different for different image locations and to generate a synthetic image based on the adaptive guidance strength.

16. The system of claim 15, wherein the image generation model comprises a classifier free guidance (CFG) diffusion model.

17. The system of claim 15, wherein computing the adaptive guidance strength comprises:
computing the conditioned tensor based on a guidance condition;
computing the unconditioned tensor independent of the guidance condition; and
computing a similarity between the conditioned tensor and the unconditioned tensor, wherein the adaptive guidance strength is based on the similarity.

18. The system of claim 15, wherein computing the adaptive guidance strength comprises:
computing an attention map based on a guidance condition, wherein the adaptive guidance strength is based on the attention map.

19. The system of claim 15, the processing device being further configured to:
determining an adaptive schedule, wherein adaptive guidance strength is further based on the adaptive schedule.

20. The system of claim 15, the system further comprising:
a text encoder configured to encode a text prompt to obtain a guidance condition, wherein the adaptive guidance strength determines a strength of the guidance condition.
